(19) United States
(12) Patent Application Publication
(10) Pub. No.: US 2003/0038756 A1
(43) Pub. Date: Feb. 27, 2003

(54) Stacked camera system for environment capture

(76) Inventors: Leo R. Blume, Palo Alto, CA (US); John M. Wilson, Sunnyvale, CA (US)

Correspondence Address: BEVER HOFFMAN & HARMS, LLP, 2099 GATEWAY PLACE, SUITE 320, SAN JOSE, CA, 951101017

(21) Appl. No.: 09/940,874

(22) Filed: Aug. 27, 2001

(51) Int. Cl. H04N 7/18

(52) U.S. Cl. 345/36; 348/159

(57) ABSTRACT

A stacked camera system in which several cameras are stacked such that the nodal point of each camera lens is aligned with a predefined axis, and each camera is directed outward from the predefined axis to capture a designated region of the surrounding environment. In one embodiment, each camera of a four-camera system captures one-quarter of a surrounding environment, with each capture region originating from a vertical axis such that horizontal blind spots and parallax are minimized.

### CROSS-REFERENCE TO RELATED APPLICATIONS

This application relates to co-filed U.S. application Ser. No. XX/XXX,XXX, entitled “VIRTUAL CAMERA SYSTEM FOR ENVIRONMENT CAPTURE” [ERT-012], which is owned by the assignee of this application and incorporated herein by reference.

### FIELD OF THE INVENTION

The present invention relates to environment mapping. More specifically, the present invention relates to multi-camera systems for capturing a surrounding environment to form an environment map that can be subsequently displayed using an environment display system.

### BACKGROUND OF THE INVENTION

Environment mapping is the process of recording (capturing) and displaying the environment (i.e., surroundings) of a theoretical viewer. Conventional environment mapping systems include an environment capture system (e.g., a camera system) that generates an environment map containing data necessary to recreate the environment of the theoretical viewer, and an environment display system that processes the environment map to display a selected portion of the recorded environment to a user of the environment mapping system. An environment display system is described in detail by Hashimoto et al., in co-pending U.S. patent application Ser. No. 09/505,337, entitled “POLYGONAL CURVATURE MAPPING TO INCREASE TEXTURE EFFICIENCY”, which is incorporated herein in its entirety. Typically, the environment capture system and the environment display system are located in different places and used at different times. Thus, the environment map must be transported to the environment display system typically using a computer network, or stored on a computer readable medium, such as a CD-ROM or DVD.

FIG. 1(A) is a simplified graphical representation of a spherical environment map surrounding a theoretical viewer in a conventional environment mapping system. The theoretical viewer (not shown) is located at an origin 105 of a three-dimensional space having x, y, and z coordinates. The environment map is depicted as a sphere 110 that is centered at origin 105. In particular, the environment map is formed (modeled) on the inner surface of sphere 110 such that the theoretical viewer is able to view any portion of the environment map. For practical purposes, only a portion of the environment map, indicated as view window 130A and view window 130B, is typically displayed on a display unit (e.g., a computer monitor) for a user of the environment mapping system. Specifically, the user directs the environment display system to display window 130A, display window 130B, or any other portion of the environment map. Ideally, the user of the environment mapping system can view the environment map at any angle or elevation by specifying an associated display window.

FIG. 1(B) is a simplified graphical representation of a cylindrical environment map surrounding a theoretical viewer in a second conventional environment mapping system. A cylindrical environment map is used when the environment to be mapped is limited in one or more axial directions. For example, if the theoretical viewer is standing in a building, the environment map may omit certain details of the floor and ceiling. In this instance, the theoretical viewer (not shown) is located at center 145 of an environment map that is depicted as a cylinder 150 in FIG. 2. In particular, the environment map is formed (modeled) on the inner surface of cylinder 150 such that the theoretical viewer is able to view a selected region of the environment map. Again, for practical purposes, only a portion of the environment map, indicated as view window 160, is typically displayed on a display unit for a user of the environment mapping system.

Many conventional camera systems exist to capture the environment surrounding a theoretical viewer for each of the environment mapping systems described with reference to FIGS. 1(A) and 1(B). For example, cameras adapted to use a fisheye, or hemispherical, lens are used to capture a hemisphere of sphere 110, i.e., half of the environment of the theoretical viewer. By using two hemispherical lens cameras, the entire environment of viewer 105 can be captured. However, the images captured by cameras with a hemispherical lens require intensive processing to remove the distortions caused by the hemispherical lens in order to produce a clear environment map. Furthermore, a camera system using two cameras with hemispherical lens provide lower resolution for capturing an environment than systems using more than two cameras.

Other environment capturing camera systems use multiple outward facing cameras. FIG. 2 depicts an outward facing camera system 200 having six cameras 211-216 facing outward from a center point C. Camera 211 is directed to capture data representing a region 221 of the environment surrounding camera system 200. Similarly, cameras 212-216 are directed to capture data representing regions 222-226, respectively. The data captured by cameras 211-216 is then combined in an environment display system (not shown) to create a corresponding environment map from the perspective of the theoretical viewer.

Several problems arise from the use of conventional outward facing camera system 200.

A first problem is the existence of blind spots (i.e., regions of the environment that are not captured by the cameras) in the environment map. Referring to FIG. 2, blind spots 231-236 are located between cameras 211-216 and captured regions 222-226. For example, blind spot 231 is located between cameras 211 and 212 and captured regions 221 and 222, and defines a region that is not in the field of views by any of the cameras. These blind spots prevent certain items located at a close range to camera system 200 from being included in the environment map.

A second problem associated with camera system 200 is parallax, i.e. the effect produced when two cameras at different locations capture the same object. This occurs when an object is located in a region (referred to herein as an “overlap region”) that is located in two or more capture regions. For example, overlapping portions of capture region 221 and capture region 222 form overlap region 241. Any object (not shown) located in overlap region 241 is captured both by camera 211 and by camera 212. Similar overlap regions 242-246 are indicated for each adjacent pair of cameras 212-216. Because the position and the point of view of each camera is different (i.e., adjacent cameras are separated by a distance D), the object is simultaneously captured from two different points of reference, and the captured images of the object are therefore different. Accordingly, when the environment map data from both of these cameras is subsequently combined in an environment display system, the environment display system is able to merge portions of the image captured by the two cameras that are essentially identical, but produces noticeable image degradation in the regions wherein the images are different.

An extension to environment mapping is generating and displaying immersive videos. Immersive videos are formed by creating multiple environment maps, ideally at a rate of at least 30 frames per second, and subsequently displaying selected sections of the multiple environment maps to a user, also ideally at a rate of at least 30 frames per second. Immersive videos are used to provide a dynamic environment, rather than a single static environment as provided by a single environment map. For example, immersive video techniques allow the location of the theoretical viewer to be moved relative to objects located in the environment. For example, an immersive video can be made to capture a flight in the Grand Canyon. The user of an immersive video display system would be able to take the flight and look out at the Grand Canyon at any angle. Camera systems for environment mappings can be easily converted for use with immersive videos by using video cameras in place of still image cameras.

Hence, there is a need for an efficient camera system for producing environment mapping data and immersive video data that minimizes the parallax and blind spot problems associated with conventional systems.

### SUMMARY OF THE INVENTION

The present invention is directed to an efficient camera system in which cameras are arranged along an axis (“stacked”) such that the nodal point of each camera lens is aligned with the axis, and each camera is directed away from the axis to capture a designated region of the surrounding environment. This stacked arrangement minimizes parallax and blind spots because, by placing all of the nodal points along the axis, adjacent cameras capture the surrounding environment from essentially the same location (i.e., a point on the axis). Note that a slight parallax is created by the stacked arrangement, but this parallax is minimized by stacking the cameras as close as possible along the axis. Accordingly, an efficient camera system is provided for generating environment mapping data and immersive video data that minimizes the parallax and blind spots problems associated with conventional camera systems.

The present invention will be more fully understood in view of the following description and drawings.

### BRIEF DESCRIPTION OF THE DRAWINGS

FIG. 1(A) is a three-dimensional representation of a spherical environment map surrounding a theoretical viewer;

FIG. 1(B) is a three-dimensional representation of a cylindrical environment map surrounding a theoretical viewer;

FIG. 2 is a simplified plan view showing a conventional outward-facing camera system;

FIG. 3 is a front view showing a stacked camera system according to a first embodiment of the present invention;

FIG. 4 is a plan view showing the stacked camera system of FIG. 3;

FIG. 5 is a perspective view depicting a cylindrical environment map generated using the stacked camera system shown in FIG. 3;

FIG. 6 is a perspective view depicting a process of displaying the environment map shown in FIG. 6;

FIG. 7 is a front view showing a stacked camera system according to a second embodiment of the present invention;

FIG. 8 is a plan view showing the stacked camera system of FIG. 7;

FIG. 9 is a perspective view depicting a semispherical environment map generated using the stacked camera system shown in FIG. 7; and

FIG. 10 is a perspective view depicting a process of displaying the environment map shown in FIG. 9.

### DETAILED DESCRIPTION

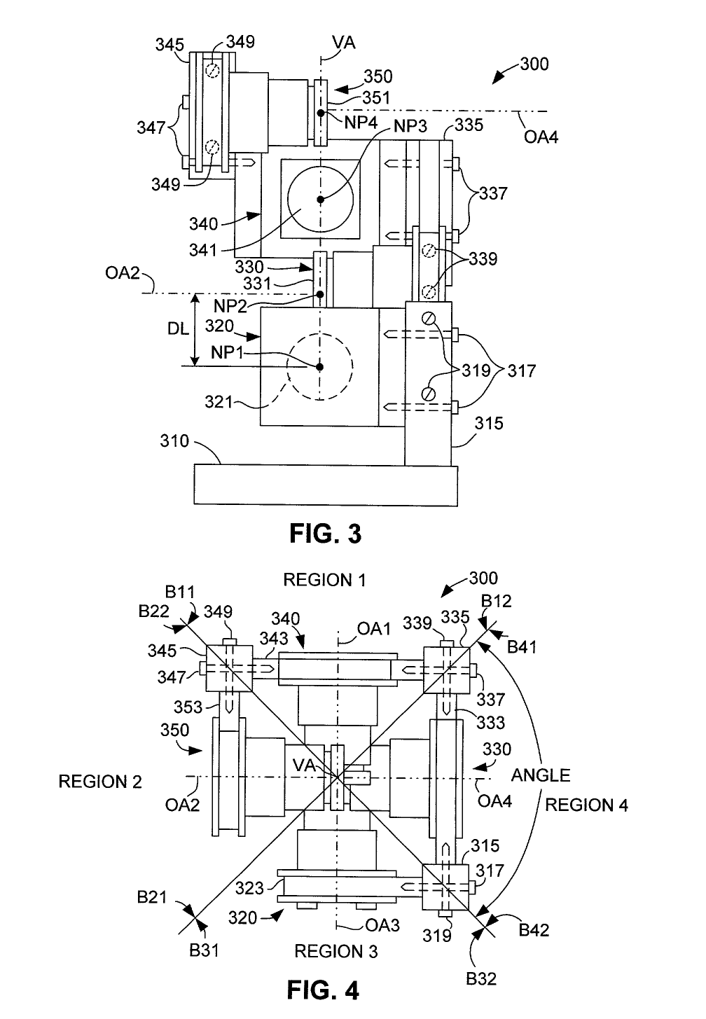

FIGS. 3 and 4 are front and plan views, respectively, showing a stacked camera system 300 in accordance with an embodiment of the present invention. Stacked camera system 300 includes four cameras 320, 330, 340, and 350 (e.g., model WDCC-5200 cameras produced by Weldex Corp. of Cerritos, Calif.) that perform the function of capturing an environment surrounding camera system 300. In an alternative embodiment, digital cameras may be utilized to capture an image. Environment data captured by each camera is transmitted via a cable (not shown) to a data storage device (also not shown) in a known manner, digitized, if need be, and combined to form an environment map that can be displayed singularly or used to form immersive video presentations.

Each camera 320, 330, 340, and 350 includes a lens defining a nodal point and an optical axis. For example, camera 320 (facing into the page) includes a lens 321 that defines a nodal point NP1 (shown in FIG. 3), and defines an optical axis OA1 (shown in FIG. 4). Similarly, camera 330 includes lens 331 that defines nodal point NP2 and optical axis OA2, camera 340 includes lens 341 that defines nodal point NP3 and optical axis OA3, and camera 350 includes lens 351 that defines nodal point NP4 and optical axis OA4.

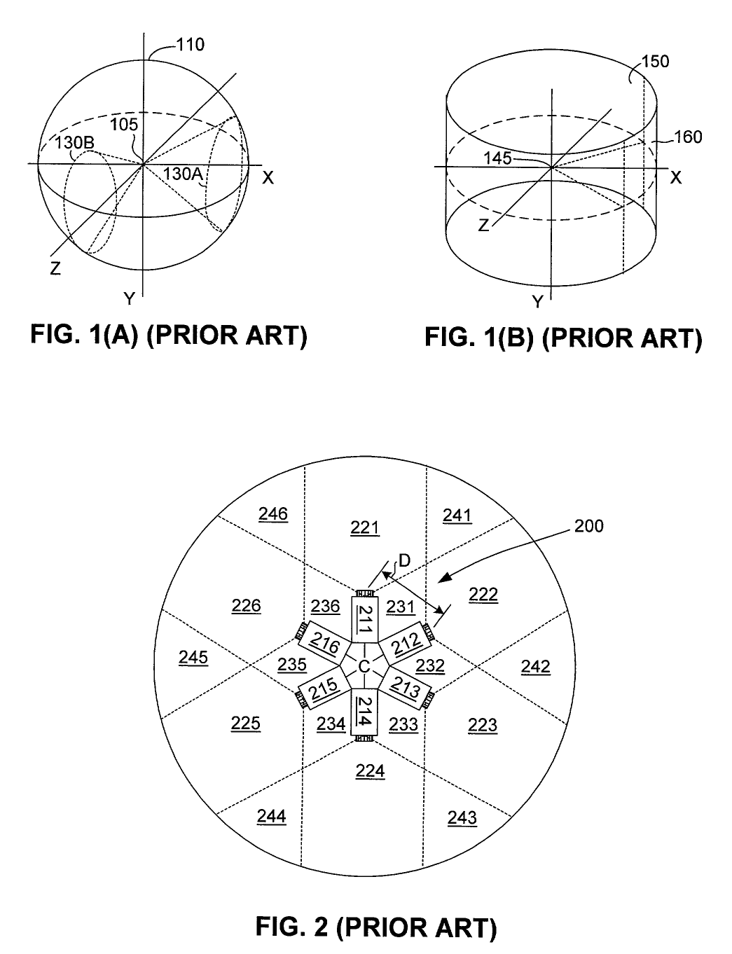

As indicated in FIGS. 3 and 4, cameras 320, 330, 340, and 350 are maintained in a stacked arrangement along a main axis (e.g., vertical) such that the optical axes defined by the respective lenses are directed perpendicular to the main axis (e.g., in horizontal directions), thereby allowing cameras 320, 330, 340, and 350 to generate environment data that is used to form a cylindrical environment map, such as that shown in FIG. 1(B). In particular, as shown in FIG. 4, optical axis OA1 of camera 320 is directed into a first capture region designated as REGION1. Similarly, optical axis OA2 of camera 330 is directed into a second capture REGION2, optical axis OA3 of camera 340 is directed into a third capture region REGION3, and optical axis OA4 of camera 350 is directed into a fourth capture region REGION4.

The respective camera lens of each camera 320, 330, 340, and 350 defines a region of the surrounding environment captured by that camera. These capture regions (also known as “fields of view” or “FOV's”) are depicted in FIG. 4 as corresponding pairs of radial horizontal boundaries that extend from the nodal point of each camera lens, and define the surrounding environment captured by each camera. For example, capture region REGION1 is defined by radial boundaries B11 and B12. Similarly, capture region REGION2 is defined by radial boundaries B21 and B22, capture region REGION3 is defined by radial boundaries B31 and B32, and capture region REGION4 is defined by radial boundaries B41 and B42. In one embodiment, each pair of radial boundaries (e.g., radial boundaries B41 and B42) define an angle (ANGLE) that is greater than 90 degrees such that each radial boundary slightly overlaps the radial boundary of an adjacent capture region (e.g., radial boundary B41 slightly overlaps radial boundary B32). Because each camera captures approximately one-quarter of the surrounding environment, all four cameras 320, 330, 340, and 350 are required to capture the entire horizontal environment surrounding camera system 300. Note that cameras 320, 330, 340, and 350 are arranged such that optical axis OA1 is perpendicular to optical axis OA2, which is perpendicular to optical axis OA3, which in turn is perpendicular to optical axis OA4.

In accordance with the present invention, cameras 320, 330, 340, and 350 are maintained in the stacked arrangement such that nodal points NP1-NP4 are aligned along a predefined axis, such as vertical axis VA. Vertical axis VA is shown in FIG. 3, and extends into the page in FIG. 4. This stacked arrangement minimizes parallax and blind spots because, by placing nodal points NP1-NP4 along vertical axis VA, each camera 320, 330, 340, and 350 captures the surrounding environment from essentially the same horizontal location. In particular, as indicated in FIG. 4, by stacking cameras 320, 330, 340, and 350 according to the present invention, blind spots are essentially eliminated because each capture region originates from the same horizontal location (i.e., vertical axis VA). Further, even though there is a slight capture region overlap located along the radial boundaries (described above), horizontal parallax is essentially eliminated because each associated camera perceives an object in this overlap region from the same horizontal position.

Note that a slight vertical parallax is created by the stacked arrangement of camera system 300. As indicated in FIG. 3, this vertical parallax may be minimized by stacking the cameras as close as possible along vertical axis VA. For example, referring to FIG. 4, cameras 320 and 330 are shown as being spaced apart by approximately the diameter DL of the camera lenses. Even with this slight vertical parallax, camera system 300 provides an efficient camera system for generating environment mapping data and immersive video data that minimizes the parallax and blind spot problems associated with conventional camera systems (discussed above).

Referring again to FIG. 3, in the disclosed embodiment, cameras 320, 330, 340, and 350 are rigidly held by a support structure including a base 310 and vertically arranged rigid members 315, 335, and 345. Each camera includes a mounting board that is fastened to a corresponding rigid member by a pair of fasteners (e.g., screws). For example, camera 320 includes a mounting board 323 that is connected by fasteners 317 to rigid member 315, which extends upward from base 310. Camera 330 includes a mounting board 333 that is connected along a first edge by fasteners 319 to rigid member 315, and along a second edge by fasteners 329 to rigid member 335. Similarly, camera 340 includes a mounting board 343 that is connected along a first edge by fasteners 337 to rigid member 335, and along a second edge by fasteners 349 to rigid member 345. Finally, camera 350 includes a mounting board 353 that is connected by fasteners 349 to rigid member 345. Note that rigid members 335, 345, and 355 do not extend down to base 310, but may in some embodiments.

Note that cameras 320, 330, 340, and 350 should be constructed and/or positioned such that the body of one camera does not protrude significantly into the capture region recorded by a second camera.

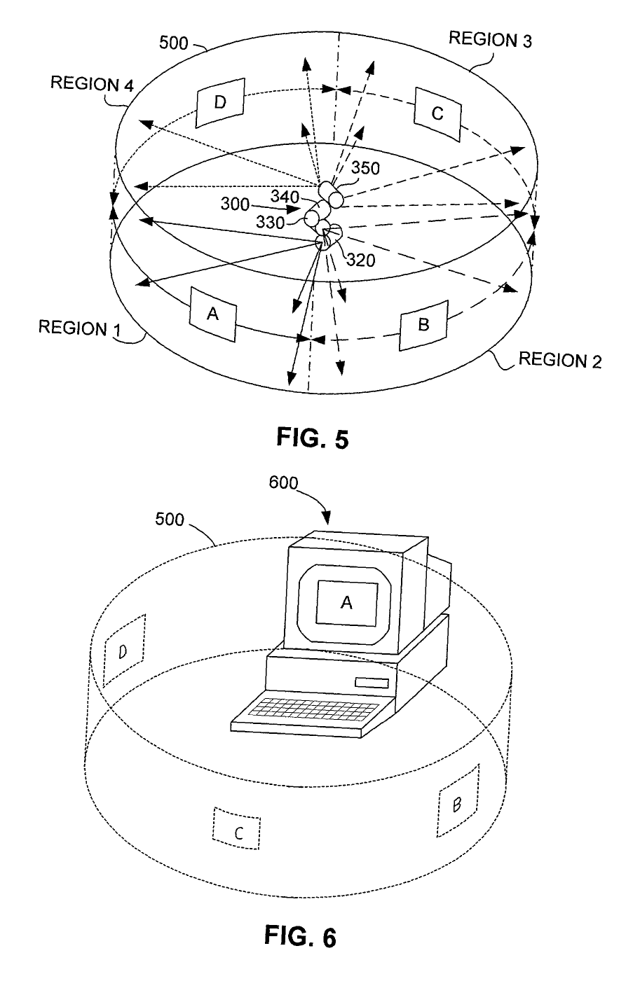

FIGS. 5 and 6 are simplified diagrams illustrating a method for generating an environment map in accordance with an aspect of the present invention.

FIG. 5 is a simplified diagram illustrating the steps of capturing environment data and generating an environment map 500 using camera system 300. In particular, each camera 320, 330, 340, and 350 is directed in the manner described above to respectively capture regions REGION1-REGION4 of the surrounding environment. The environment data captured by cameras 320, 330, 340, and 350 collectively forms environment map 500, which is depicted in FIG. 5 as a cylinder. For example, camera 320 captures environment data from capture region REGION1, which includes an object “A”. This environment data is then combined with captured environment data from camera 330 (i.e., capture region REGION2), camera 340 (i.e., capture region REGION3), and camera 350 (i.e., capture region REGION4) to generate environment map 500.

Note that the environment data captured by cameras 320, 330, 340, and 350 may be combined in a processor (not shown) connected to camera system 300, and then provided in the combined video data form to a display system (such as the environment display system shown in FIG. 6). Alternatively, the non-combined video data can by combined by a processor provided in an environment display system, such as that shown in FIG. 6. Further, the environment data captured by cameras 320, 330, 340, and 350 may be still (single frame) data, or multiple frame data produced in accordance with known immersive video techniques.

FIG. 6 is a simplified diagram illustrating the step of displaying the environment map 500 generated as described above. A computer 600 is configured to implement an environment display system, such as that disclosed in co-pending U.S. patent application Ser. No. 09/505,337 (cited above). As indicated in FIG. 6, only a portion of environment map 500 (e.g., object “A” from capture region REGION1 (see FIG. 5) is displayed at a given time. To view other portions of environment map 500, a user manipulates computer 600 such that the implemented environment display system “rotates” environment map 500 to, for example, display an object “B” from capture region REGION2 (see FIG. 5).

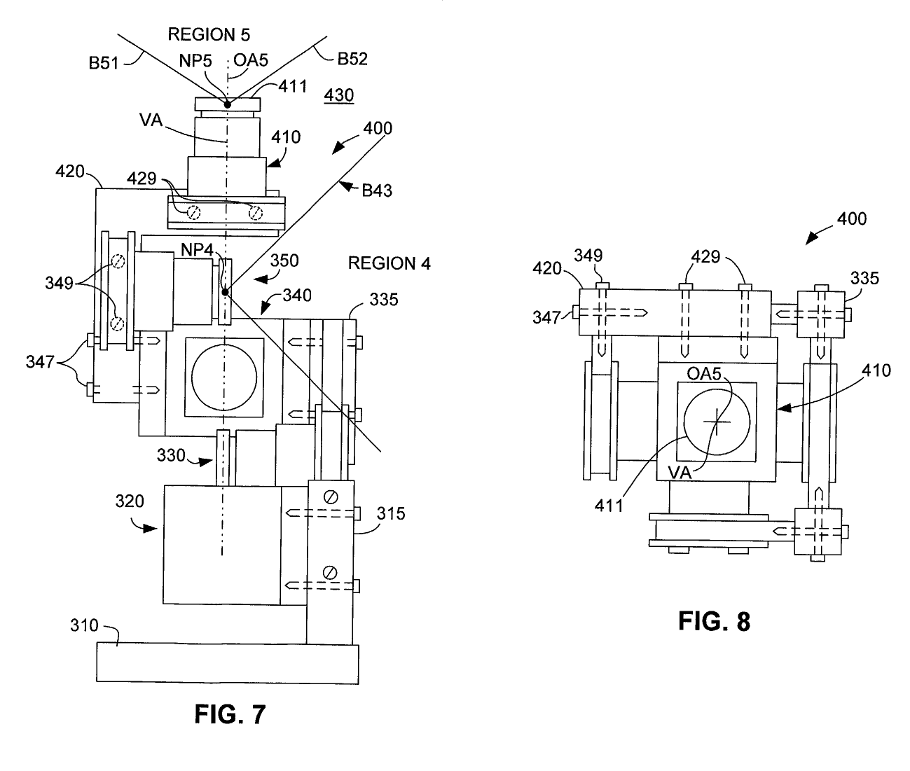

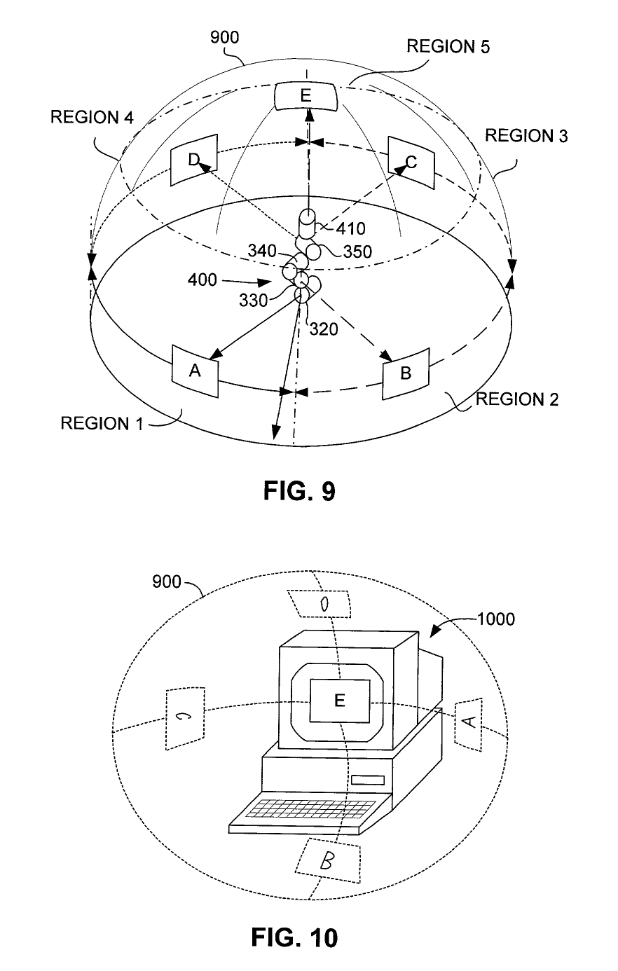

FIGS. 7 and 8 are front and plan views, respectively, showing a stacked camera system 400 in accordance with a second embodiment of the present invention. Camera system 400 includes cameras 320, 330, 340, and 350 that are utilized in camera system 300 (described above), and also includes a fifth camera 510 that is mounted above cameras 320, 330, 340, and 350 and has lens 411 defining a nodal point NP5 and an optical axis OA5 that is directed vertically upward. In particular, optical axis OA5 of camera 510 is co-linear with vertical axis VA, which, as described above, passes through the nodal points of cameras 320, 330, 340, and 350, and is directed into a capture region REGION5, which is located over camera system 400 and is indicated by radial boundary lines B51 and B52 in FIG. 7. Note that capture region REGION5 is separated from the capture regions of cameras 320, 330, 340, and 350 in the vicinity of camera system 400. For example, as indicated at the upper portion of FIG. 7, upper radial boundary line B43 (which defines an uppermost boundary of capture region REGION4) is displaced from radial boundary line B52. This displacement creates a blind spot region 430 and may produce vertical parallax when environment map data captured by camera 410 is combined with environment data captured by cameras 320, 330, 340, and 350. However, blind spot region 430 is typically small and is located above the “line of sight” of the theoretical viewer, and is therefore considered less important than other blind spots. Though there may be more vertical parallax between camera 410 and camera 350 than between camera 350 and 340, the vertical parallax will typically be small and the horizontal parallax will still be close to zero. In alternative embodiments, such as that shown in FIGS. 9 and 10 and discussed below, one or more cameras can included that are directed along the main axis of the system (e.g., vertical axis VA) to capture these blind spots.

Similar to camera system 300 (shown in FIGS. 3 and 4), camera system 400 is rigidly held by a support structure including base 310 and vertically arranged rigid members 315 and 335. However, unlike camera system 300, camera system 400 utilizes an angled member 420 in place of vertical rigid member 345 to secure camera 410 to cameras 340 and 350. Angled member 420 includes a vertical portion that is connected to camera 340 by fasteners 347 and to camera 350 by fasteners 349. In addition, angled member 420 includes a horizontal portion that is connected to camera 410 by fasteners 429.

FIGS. 9 and 10 are simplified diagrams illustrating a method for generating an environment map utilizing camera system 400. FIG. 9 shows the process of capturing environment data and generating an environment map 900 using camera system 400. In particular, each camera 320, 330, 340, and 350 is directed in the manner described above to respectively capture regions REGION1-REGION4 of the surrounding environment. In addition, camera 410 is directed upward to capture region REGION5. The environment data captured by cameras 320, 330, 340, 350, and 410 collectively forms environment map 900, which is depicted in FIG. 9 as a semi-sphere. In addition to objects “A” through “D”, respectively captured by cameras 320, 330, 340, and 350, an additional object “E” located in capture region REGION5 is shown in the upper portion of environment map 900. FIG. 10 is a simplified diagram illustrating the step of displaying the environment map 900 generated as described above. A computer 1000 is configured to implement an environment display system, such as that disclosed in copending U.S. patent application Ser. No. 09/505,337 (cited above). As indicated in FIG. 10, only a portion of environment map 900 (e.g., object “E” from capture region REGION5 is displayed at a given time. To view other portions of environment map 900, a user manipulates computer 1000 such that the implemented environment display system “rotates” environment map 900 to, for example, display an object “B” from capture region REGION2 (see FIG. 9).

Although the present invention has been described with respect to certain specific embodiments, it will be clear to those skilled in the art that the inventive features of the present invention are applicable to other embodiments as well. For example, the number of cameras incorporated into a camera system of the present invention can be reduced by using lenses that capture a wider region of the surrounding environment. Further, the environment captured by a camera system of the present invention may include only a portion of the actual environment surrounding the camera system (e.g., only regions REGION1 and REGION2 in FIG. 5). Conversely, a camera system may include more than four cameras to capture the 360-degree environment surrounding the camera system at a greater resolution that the four camera systems described herein. In addition, an additional camera can be added to the camera systems described herein that is directed downward along the vertical axis in a manner similar to upward-facing camera 410 (see FIG. 9). All such embodiments are intended to fall within the scope of the present invention.

1. A stacked camera system for environment capture comprising:
a plurality of cameras, each camera having a lens defining a nodal point and an optical axis; and
a support structure for maintaining the plurality of cameras in a stacked arrangement such that the nodal points defined by the lens of each of the plurality of cameras is aligned along a predefined axis, and wherein the optical axis defined by the lens of each of the plurality of cameras is directed away from the predefined axis.

2. The stacked camera system according to claim 1,
wherein the predefined axis is aligned in a vertical direction, and
wherein the optical axes defined by the lenses of the plurality of cameras are directed in horizontal directions.

3. The stacked camera system according to claim 2,
wherein the optical axis defined by the lens of a first camera is directed in a first horizontal direction,
wherein the optical axis defined by the lens of a second camera is directed in a second horizontal direction, and
wherein the first horizontal direction is perpendicular to the second horizontal direction.

4. The stacked camera system according to claim 1, wherein the plurality of cameras comprise:
a first camera positioned such that the optical axis defined by the lens of the first camera is directed in a first direction;
a second camera positioned such that the optical axis defined by the lens of the second camera is directed in a second direction that is perpendicular to the first direction;
a third camera positioned such that the optical axis defined by the lens of the third camera is directed in a third direction that is perpendicular to the second axis; and
a fourth camera positioned such that the optical axis defined by the lens of the fourth camera is directed in a fourth direction that is perpendicular to the first and third directions.

5. The stacked camera system according to claim 4, wherein the stacked camera system further comprises a fifth camera positioned such that the optical axis defined by the lens of the fifth camera is co-linear with the predefined axis.

6. The stacked camera system according to claim 1,
wherein each of the plurality of cameras is configured to capture a predefined region of an environment surrounding the stacked camera system,
wherein a first predefined region captured by a first camera is defined by a first radial boundary and a second radial boundary,
wherein a second predefined region captured by a second camera is defined by a third radial boundary and a fourth radial boundary, and
wherein the first radial boundary partially overlaps the third boundary.

7. The stacked camera system according to claim 6, wherein the first radial boundary and the second radial boundary define an angle in the range of 55 to 125 degrees.

8. The stacked camera system according to claim 6, wherein the first radial boundary and the second radial boundary define an angle greater than 90 degrees.

9. The stacked camera system according to claim 1, wherein the support structure comprises:
a base;
a first portion extending upward from the base and being connected to a first camera and to a first side edge of a second camera;
a second portion connected to a second side edge of the second camera and to a first side edge of a third camera; and
a third portion connected to a second side edge of the third camera and to a fourth camera.

10. The stacked camera system according to claim 9,
wherein the first camera is positioned such that the optical axis defined by the lens of the first camera is directed in a first direction;
wherein the second camera is positioned such that the optical axis defined by the lens of the second camera is directed in a second direction that is perpendicular to the first direction;
wherein the third camera is positioned such that the optical axis defined by the lens of the third camera is directed in a third direction that is perpendicular to the second axis; and
wherein the fourth camera is positioned such that the optical axis defined by the lens of the fourth camera is directed in a fourth direction that is perpendicular to the first and third directions.

11. The stacked camera system according to claim 10, wherein the stacked camera system further comprises a fifth camera mounted on the third portion and positioned such that the optical axis defined by the lens of the fifth camera is co-linear with the predefined axis.

12. A stacked camera system for environment capture comprising a plurality of cameras, each camera having a lens defining a nodal point and an optical axis, wherein the plurality of cameras are stacked such that the nodal points defined by the lens of each of the plurality of cameras is aligned along a predefined axis, and wherein the optical axis defined by the lens of each of the plurality of cameras is directed away from the predefined axis.

13. A method for generating an environment map comprising:
capturing environment data using a plurality of cameras, each camera having a lens defining a nodal point and an optical axis, wherein the plurality of cameras are stacked such that the nodal points defined by the lens of each of the plurality of cameras is aligned along a predefined axis, and wherein the optical axis defined by the lens of each of the plurality of cameras is directed away from the predefined axis,
combining the captured environment data from the plurality of camera to form an environment map, and
displaying the environment map using an environment display system.

14. The method according to claim 13, wherein capturing the environment data further comprises arranging the plurality of cameras such that the predefined axis is aligned in a vertical direction and the optical axes defined by the lenses of the plurality of cameras are directed in horizontal directions.

15. The method according to claim 14, wherein capturing the environment data further comprises:
directing the optical axis defined by the lens of a first camera in a first horizontal direction, and
directing the optical axis defined by the lens of a second camera in a second horizontal direction,
wherein the first horizontal direction is perpendicular to the second horizontal direction.

16. The method according to claim 13, wherein capturing the environment data further comprises:
positioning a first camera such that the optical axis defined by the lens of the first camera is directed in a first direction;
positioning a second camera such that the optical axis defined by the lens of the second camera is directed in a second direction that is perpendicular to the first direction;
positioning a third camera such that the optical axis defined by the lens of the third camera is directed in a third direction that is perpendicular to the second axis; and
positioning a fourth camera such that the optical axis defined by the lens of the fourth camera is directed in a fourth direction that is perpendicular to the first and third directions.

17. The method according to claim 16,
wherein the first, second, third and fourth directions define a horizontal plane, and
wherein capturing the environment data further comprises positioning a fifth camera positioned such that the optical axis defined by the lens of the fifth camera is directed in a fifth direction that is perpendicular to the horizontal plane.
